(19) United States
(12) Patent Application Publication
(10) Pub. No.: US 2016/0203496 A1
(43) Pub. Date: Jul. 14, 2016

(54) Multivariate Dynamic Rules Engine Framework and System

(71) Applicant: Optima Compass Group, LLC, Austin, TX (US)

(72) Inventors: Jorge Guerrero, Austin, TX (US); Harrison Sanclemente, Margate, FL (US)

(73) Assignee: Optima Compass Group, LLC, Austin, TX (US)

(21) Appl. No.: 14/992,639

(22) Filed: Jan. 11, 2016

Related U.S. Application Data
(60) Provisional application No. 62/102,492, filed on Jan. 12, 2015.

(51) Int. Cl. G06Q 30/00; G06Q 20/38

(52) U.S. Cl. CPC G06Q 30/0185; G06Q 20/38

(57) ABSTRACT

A process, framework and system for monitoring and managing financial transactions to assure compliance with customizable sets of standards are disclosed. The Multivariate Dynamic Rules Engine Framework and System invention comprises a plurality of modules for evaluating financial transactions, including the Get Review Criteria Module, the Evaluate Single Transaction Rules Module, the Evaluate Profile Rules Module, and the Evaluate Accumulation Rules Module; a Rules Repository; a Transaction Repository; and a set of Rules Exceptions. If any of the customizable rules for any of the modules is violated, then the Multivariate Dynamic Rules Engine generates an Exception Alert. The Multivariate Dynamic Rules Engine Framework and System invention is an automated and convenient means of assuring that financial transactions comply with a customizable set of standards in order to prevent money laundering and fraud.

### CROSS-REFERENCE TO RELATED APPLICATIONS

This application claims benefit of U.S. Provisional Patent Application No. 62102492, which was filed on Jan. 12, 2015, and which is incorporated herein in its entirety. Additionally, this application is related to Provisional Patent Application No. 62102512 filed on Jan. 12, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the technical field of financial transaction management. More particularly, the preferred embodiments of the present invention relate generally to processes, frameworks and systems for monitoring and managing financial transactions. More particularly, the preferred embodiments of the present invention relate generally to processes, frameworks and systems for monitoring and managing financial transactions to assure compliance with a set of standards. More particularly, the preferred embodiments of the present invention relate generally to processes, frameworks and systems for monitoring and managing financial transactions to assure compliance with anti-money laundering and anti-fraud standards. More particularly, the preferred embodiments of the present invention relate generally to processes, frameworks and systems for monitoring and managing financial transactions to assure compliance with a set of standards, which are customizable. More particularly, the preferred embodiments of the present invention relate generally to processes, frameworks and systems for monitoring and managing financial transactions to assure compliance with a set of standards, which are customizable in terms of type of standards and the degree to which the standards are applied.

2. Description of the Related Art

The broad concept of systems that monitor financial transactions are known. These inventions usually involve the mere collection of financial data.

It is also known to use rules to monitor anti-money laundering compliance. However, the rules used in these inventions are immutable or provided by a government or other regulatory organization.

Dynamic anti-money laundering systems are also known. However, these existing inventions do not allow for the customization of rules by both type and degree and often attribute their dynamic nature to the dynamics of a market or the financial system.

It is also known to generate alerts for financial transactions. However, these inventions do not disclose alerts based on dynamic rules, which are customizable in both type and degree.

It is also known to use methods for detecting suspicious activity. However, these inventions usually rely on suspicious activity, which is defined by a government or other regulatory organizations and do not account for internal definitions of suspicious activity, which are customizable in both type and degree.

It is also known to use modules within systems. However, these existing inventions do not use interactive modules that subdivide the analysis of financial transactions to allow for dynamic layers of customized rules in both type and degree.

### SUMMARY OF THE INVENTION

The broad embodiments of the present invention relates to a process, framework and system for monitoring and managing financial transactions to assure compliance with customizable sets of standards, which comprises a plurality of interactive modules with sets of rules that are customizable by both type and degree.

In the most preferred embodiment, the Multivariate Dynamic Rules Engine Framework and System invention relates to a process, framework and system for monitoring and managing financial transactions to assure compliance with customizable sets of standards. In the Multivariate Dynamic Rules Engine Framework and System, financial transactions may be entered through an API, by using files or by manual input. The API implements a web service, which is called by an Internet-connected device when a transaction needs to be reviewed and which gathers the appropriate transaction information for analysis. Alternatively, text files containing transaction records can be loaded into the system through a functionality that allows a user to both select the file to load and define the internal layout of the file. Manual entry of relevant transaction information into the system is also possible. The Multivariate Dynamic Rules Engine Framework and System invention comprises a plurality of modules for evaluating financial transactions, including the Get Review Criteria Module, the Evaluate Single Transaction Rules Module, the Evaluate Profile Rules Module, and the Evaluate Accumulation Rules Module; a Rules Repository; a Transaction Repository; and a set of Rules Exceptions. Using the input transaction data, the Get Review Criteria Module obtains the base criteria to be used to filter the rules that apply to the transaction and gathers profile data to be used to evaluate the rules. Base criteria may include, but is not limited to, the following: product, currency, bank accounts, IP address, FIC, Correspondent, and/or other basic information regarding the Participants to the financial transactions, such as name, internal ID, country, state, address, phone numbers, identification numbers, DOB, email, bitcoin address, or the like. Profile data may include FIC profile, Correspondent profile and/or Participants' profiles. The Evaluate Single Transaction Rules Module evaluates all rules that are based on transactional data without running any accumulations on the Transaction Repository. The Evaluate Single Transaction Rules Module first filters the rules that apply to the transaction based on the product, currency, countries, states, FICs and correspondents and then runs the processes that evaluate each filtered rule and checks for any rule exception for either the funder or beneficiary of the transaction. The Evaluate Profile Rules Module evaluates all rules that are based on the FIC, Correspondent and Participants' profiles. Some of these rules can run accumulations on the Transaction Repository when being evaluated. The Evaluate Profile Rules Module first filters the rules that apply to the transaction based on the product, currency, countries, states, FICs and correspondents and then runs the processes that evaluate each rule and checks for any rule exception for either the funder or beneficiary of the transaction. The Evaluate Accumulation Rules Module evaluates all rules that are based on accumulations in the Transaction Repository. The Evaluate Accumulation Rules Module first filters the rules that apply to the transaction based on the product, currency, countries, states, FICs and correspondents and then runs the processes that evaluate each rule and checks for any rule exception for either the funder or beneficiary of the transaction. For each module, the user may customize the applicable rules. If any of the rules for any of the modules is violated, then the Multivariate Dynamic Rules Engine generates an Exception Alert. The Exception Alert can contain single or multiple rule violations. In addition the Multivariate Dynamic Rules Engine is designed to run in conjunction with a Sanctions Lists Engine, which takes all participants in a transaction and screens their names against several sanctions lists supported by the system using an algorithm that returns approximate matches based on a relevance rating set by the user. In sum, the Multivariate Dynamic Rules Engine Framework and System invention is an automated and convenient means of assuring that financial transactions comply with a customizable set of standards in order to prevent money laundering and fraud.

### BRIEF DESCRIPTION OF THE DRAWING

Illustrative and preferred embodiments of the present invention are shown in the accompanying drawings in which:

FIG. 1 is a view of a diagram of the present invention.

### DETAILED DESCRIPTION OF THE PREFERRED EMBODIMENTS

For the purpose of illustration, the present invention is shown in the most preferred embodiment of a process, framework and system for monitoring and managing financial transactions to assure compliance with customizable sets of standards, which comprises a plurality of interactive modules with sets of rules that are customizable by both type and degree. The most preferred embodiment is intended to run on a computer or mobile device, which accesses the system that facilitates the invention. This embodiment is not intended to limit the scope of the present invention.

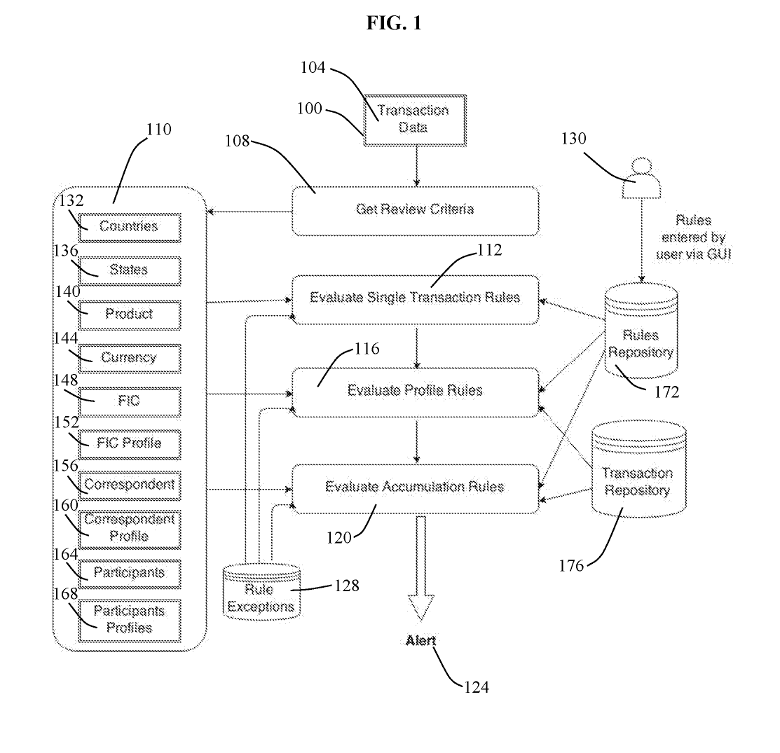

Referring now to the most preferred embodiment of the invention, FIG. 1 illustrates a diagram of the Multivariate Dynamic Rules Engine Framework and System 100, showing the interrelation between the modules 108, 112, 116, 120 of the invention and describing the process flow of generating exception alerts 124.

In further detail, still referring to the invention of FIG. 1, the Multivariate Dynamic Rules Engine Framework and System 100 comprises a plurality of modules 108, 112, 116, 120 for evaluating financial transactions; including the Get Review Criteria Module 108, the Evaluate Single Transaction Rules Module 112, the Evaluate Profile Rules Module 116, and the Evaluate Accumulation Rules Module 120; a Rules Repository 172; a Transaction Repository 176; and a set of Rules Exceptions 128. Before any financial transaction is evaluated, a user 130 of the Multivariate Dynamic Rules Engine Framework and System 100 enters custom rules (or selects default rules that are customizable) into the Rules Repository 172 using a GUI (Graphic User Interface). These rules may include acceptable and/or unacceptable properties of a financial transaction. To evaluate a financial transaction, transaction data 104 may be entered through an API (Application Programming Interface), by using files or by manual input. The API implements a web service, which is called by an Internet-connected device when a transaction needs to be reviewed and which gathers the appropriate transaction information for analysis. Alternatively, text files containing transaction records can be loaded into the system through a functionality that allows a user to both select the file to load and define the internal layout of the file. Manual entry of relevant transaction information into the system is also possible. Using the input transaction data 104, the Get Review Criteria Module 108 obtains the base criteria 110 to be used to filter the rules that apply to the transaction and gathers profile data to be used to evaluate the rules. Base criteria 110 may include, but is not limited to, the following: product 140, currency 144, bank accounts, IP address, FIC 148, Correspondent 156, and/or other basic information regarding the Participants 164 to the financial transactions, such as name, internal ID, country 132, state 136, address, phone numbers, identification numbers, DOB, email, bitcoin address, or the like. Profile data may include FIC profile 152, Correspondent profile 160 and/or Participants' profiles 168. The Evaluate Single Transaction Rules Module 112 takes the gathered base criteria 110 and profile data from the Get Review Criteria Module 108, collects Rule Exceptions 128, and evaluates all rules from the Rules Repository 172 that are based on transaction data 104 without running any accumulations on the Transaction Repository 176. The Evaluate Single Transaction Rules Module 112 first filters the rules that apply to the transaction based on the product 140, currency 144, countries 132, states 136, FICs 148 and correspondents 156 and then runs the processes that evaluate each filtered rule and checks for any rule exception for either the funder or beneficiary of the transaction. The Evaluate Profile Rules Module 116 takes the gathered base criteria 110 and profile data from the Get Review Criteria Module 108, collects Rule Exceptions 128, and evaluates all rules from the Rules Repository 172 that are based on the FIC 148, Correspondent 156 and Participants' profiles 168. In the Evaluate Profile Rules Module 116 some of these rules can run accumulations on the Transaction Repository 176 when being evaluated. The Evaluate Profile Rules Module 116 first filters the rules that apply to the transaction based on the product 140, currency 144, countries 132, states 136, FICs 148 and correspondents 156 and then runs the processes that evaluate each rule and checks for any rule exception for either the funder or beneficiary of the transaction. The Evaluate Accumulation Rules Module 120 takes the gathered base criteria 110 and profile data from the Get Review Criteria Module 108, collects Rule Exceptions 128, and evaluates all rules that are based on accumulations in the Transaction Repository 176. The Evaluate Accumulation Rules Module 120 first filters the rules that apply to the transaction based on the product 140, currency 144, countries 132, states 136, FICs 148 and correspondents 156 and then runs the processes that evaluate each rule and checks for any rule exception for either the funder or beneficiary of the transaction. For each module 108, 112, 116, 120, the user may customize the applicable rules. If any of the rules for any of the modules 108, 112, 116, 120 is violated, then the Multivariate Dynamic Rules Engine Framework and System 100 generates an Exception Alert 124. The Exception Alert 124 can contain single or multiple rule violations. In addition the Multivariate Dynamic Rules Engine 100 is designed to run in conjunction with a Sanctions Lists Engine, which takes all participants in a transaction and screens their names against several sanctions lists supported by the system using an algorithm that returns approximate matches based on a relevance rating set by the user.

The construction details of the invention as shown in FIG. 1 are that Multivariate Dynamic Rules Engine Framework and System 100 comprises a plurality of modules 108, 112, 116, 120 for evaluating financial transactions, which is comprised of software, or the like, that resides on a computer, or the like, or is accessible through an Internet-connected device.

The advantages of the present invention include, without limitation, that it provides an efficient and easy-to-use means of customizing rules, by both type and degree, for evaluating financial transactions in order to prevent money laundering and fraud.

In broad embodiment, the present invention is a process, framework and system for monitoring and managing financial transactions to assure compliance with customizable sets of standards, which comprises a plurality of interactive modules with sets of rules that are customizable by both type and degree. In sum, the Multivariate Dynamic Rules Engine Framework and System invention is an automated and convenient means of assuring that financial transactions comply with a customizable set of standards in order to prevent money laundering and fraud.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

What is claimed is:

1. A method for monitoring and managing financial transactions to assure compliance with customizable sets of standards, said method comprising:
providing a web service on one or more servers, which are configured to host said web service, said web service comprising
a Rules Repository, said Rules Repository comprising a first database of customizable rules;
a Transaction Repository, said Transaction Repository comprising a second database of accumulations of past financial transactions;
a Set of Rules Exceptions, said Set of Rules Exceptions comprising a third database of customizable exceptions to said customizable rules of said Rules Repository;
a Get Review Criteria Module;
an Evaluate Single Transaction Rules Module;
an Evaluate Profile Rules Module; and
an Evaluate Accumulation Rules Module;
providing an Application Programming Interface, which is configured to allow an Internet-connected device to remotely implement said web service;
receiving financial transaction data for said financial transactions into said web service from a user operating said Application Programming Interface on said Internet-connected device;
wherein said Get Review Criteria Module
uses said financial transaction data to obtain base criteria data related to said financial transaction data, said base criteria data comprising
product information of said financial transactions,
currency information of said financial transactions,
bank accounts information of said financial transactions,
IP addresses involved in said financial transactions,
FIC of said financial transactions,
correspondents involved in said financial transactions,
names of participants to said financial transactions,
internal ID of said participants to said financial transactions,
countries of said participants to said financial transactions,
state of said participants to said financial transactions,
addresses of said participants to said financial transactions,
phone numbers of said participants to said financial transactions,
identification numbers of said participants to said financial transactions,
dates of birth of said participants to said financial transactions,
email addresses of said participants to said financial transactions, and
bitcoin address of said participants to said financial transactions;
uses said financial transaction data to gather said profile data related to said financial transaction data, said profile data comprising
FIC profile,
correspondents' profiles, and
participants' profiles; and
provides said base criteria data and said profile data to said Evaluate Single Transaction Rules Module, said Evaluate Profile Rule Module and said Evaluate Accumulation Rules Module;
wherein said Evaluate Single Transaction Rules Module
accesses said Rules Repository, said Transaction Repository, and said Set of Rule Exceptions;
evaluates all said customizable rules from said Rules Repository that are based on said financial transaction data without accessing said accumulations from said Transaction Repository;
filters said customizable rules that apply to said financial transactions based on
said product information,
said currency information,
said countries,
said states,
said FICs, and
said correspondents; and
runs single transaction evaluation processes that evaluate said financial transaction data under each filtered said customizable rule; and
checks said Set of Rules Exceptions for any said customizable exception for either the funder or beneficiary of said financial transactions;
wherein said Evaluate Profile Rules Module
accesses said Rules Repository, said Transaction Repository, and said Set of Rule Exceptions;
evaluates all said customizable rules from said Rules Repository that are based on said profile data;
filters said customizable rules that apply to said financial transactions based on
said product information,
said currency information,
said countries,
said states,
said FICs, and
said correspondents; and
runs profile evaluation processes that evaluate said financial transaction data under each filtered said customized rule; and
checks said Set of Rules Exceptions for any said customizable exception for either said funder or said beneficiary of said financial transactions;
wherein said Evaluate Accumulation Rules Module
accesses said Rules Repository, said Transaction Repository, and said Set of Rule Exceptions;
evaluates all said customizable rules from said Rules Repository that are based on said accumulations in said Transaction Repository
filters said customizable rules that apply to said financial transactions based on
said product information,
said currency information,
said countries,
said states,
said FICs, and
said correspondents; and
runs accumulation evaluation processes that evaluate said financial transaction data under each filtered said customizable rule; and
checks said Set of Rules Exceptions for any said customizable exception for either said funder or said beneficiary of said financial transactions;
wherein, if any of said customizable rules for any of said Get Review Criteria Module, said Evaluate Single Transaction Rules Module, said Evaluate Profile Rules Module, or said Evaluate Accumulation Rules Module, is violated, said web service generates an Exception Alert, said Exception Alert comprising single or multiple violations of said customizable rules.

2. The method of claim 1, further comprising said user entering said financial transaction data into said Application Programming Interface manually.

3. The method of claim 1, further comprising said user entering said financial transaction data into said Application Programming Interface using text files comprising transaction records, which are loaded into said web service through a functionality that allows said user to both select said text file to load and define the internal layout of said text file.

4. The method of claim 1, further comprising running said web service in conjunction with a Sanctions Lists Engine, which takes all said participants in said financial transactions and screens said participants' names against several sanctions lists supported by the said web service using an algorithm that returns approximate matches based on a relevance rating set by said user.
